(19) United States
(12) Patent Application Publication
(10) Pub. No.: US 2007/0107767 A1
(43) Pub. Date: May 17, 2007

(54) DC power-generation system and integral control apparatus therefor

(75) Inventors: Herbert T. Hayden, Tempe, AZ (US); William Jeffrey Schlanger, Flagstaff, AZ (US)

Correspondence Address: MESCHKOW & GRESHAM, P.L.C., 5727 NORTH SEVENTH STREET, SUITE 409, PHOENIX, AZ, 85014, US

(73) Assignee: Arizona Public Service Company, Phoenix, AZ (US)

(21) Appl. No.: 11/281,970

(22) Filed: Nov. 16, 2005

(51) Int. Cl. H02N 6/00

(52) U.S. Cl. 136/244; 136/293

(57) ABSTRACT

A DC power-generation array system (30) is made up of an array (32) of power-generation cells (36) arranged as N strings (38) of M cells (36) each. The system (30) incorporates an integral control apparatus (34) having N string units (52) and a single process unit (54). Each string unit (52) is coupled to one of the strings (38), and is made up of monitor module (72) to measure a string current (I_{S(X)}) through that string (38), and a switching module (74) to switch that string (38) into and out of the array (32). The process unit (54) is made up of a processor (90) to evaluate the string currents (I_{S(X)}, and a data I/O module (98) to provide a remote monitoring and control of the system (30). The system (30) also has an interface unit (92) to provide local monitoring and control of the system (30). The processor (90) causes the switching modules (74) to couple or decouple strings (38) from array (32) under automatic, remote, and/or local control.

### TECHNICAL FIELD OF THE INVENTION

The present invention relates to the field of direct-current power generation. More specifically, the present invention relates to the field of direct-current power-generation systems utilizing arrays of power-generation cells.

### BACKGROUND OF THE INVENTION

FIG. 1 shows a prior-art direct-current (DC) solar power-generation system 10 in basic form. A solar generating station (not shown) may contain many such systems, effectively coupled in parallel, to produce the desired power.

The system is made up of a DC power-generation solar array 11 arranged as a plurality of strings 12, with each string typically containing a multiplicity of series-connected DC power-generation solar cells (not shown). A given string is therefore a “string” of cells.

Each string has a positive string output 13 and a negative string output 14. All positive string outputs electrically couple to a positive current summing bus 15, and all negative string outputs electrically couple to a negative current summing bus 16.

The solar cells making up a given string are electrically in series. Each string therefore has a string current that is substantially equal to a current through each solar cell in that string, and a string voltage that is substantially equal to a sum of the voltages of each of the solar cells in that string. The positive and negative summing buses place all strings in the array in parallel. The array, and the system, therefore has an array current that is substantially equal to a sum of all the string currents, and an array voltage substantially equal to an average of the string voltages. A positive array output 17 is taken from the positive summing bus, and a negative array output 18 is taken from the negative summing bus.

In some cases, it is desirable to include protection, monitoring, and/or connection control in the system. This may be accomplished through the insertion of several discrete components into the system. In the system of FIG. 1, for example a fuse 19, a monitoring circuit 20, and a switching circuit 21 have been inserted as discrete components and coupled between each string and the summing buses. The positive string output of each string is shown electrically coupled to the fuse by a first interconnect 22. The fuse is shown electrically coupled to the monitor circuit by a second interconnect 23. The monitor circuit is shown electrically coupled to the switching circuit by a third interconnect 24. The negative string output is shown electrically coupled to the negative summing bus by a fifth interconnect 26. In addition, a switching circuit typically requires a negative connection to the associated string. The switching circuit is therefore shown electrically coupled to the negative summing bus by a sixth interconnect 27.

There are, however, several problems in the implementation of this system. One of these problems is the number of interconnects involved, which can fail in several ways.

Interconnects are cables or wires that must reliably carry a full string current, and that desirably have a low internal resistance to minimize power losses. In the system of FIG. 1, there are six such interconnects per string. In an array of fifteen strings, for example, there would be ninety interconnects that must be routed, installed, and maintained. Each interconnect has two connection points, one at each end, that each pose a risk of failure do to poor connections initially (installation problems) or over time due to thermal expansion and contraction, vibration, corrosion, etc. Each of these connection points is therefore a potential point of failure. In point of fact, these connection-point failures may be more likely in an average installation than is a failure of a solar cell within the array.

An interconnect connection may become disconnected. Should this occur, the relevant string would be electrically removed from the array. Besides the obvious potential loss of energy involved, the disconnected end of the interconnect may contact another component of the system, thereby establishing a short circuit. This short circuit may cause a failure of a string, of the solar array, or, in extreme cases, of the solar generating station itself. Such a short circuit may cause localized dissipation of high energy. This may lead to the production of excessive heat and potentially result in fire.

An interconnect connection may become intermittent. Such an intermittent connection may significantly affect the capacity of array, and may produce electrical noise that may adversely affect other components of the solar generation station, e.g., inverters, computers, controllers, etc.

An interconnect connection may become corroded or otherwise suffer an increase in the connection resistance. This may result in a decrease in the output of a string, with a corresponding decrease in the capacity of the array. Corrosion is pervasive. Where one connection has corroded, other connections are likely to be corroding. This pervasive nature of corrosion may lead to a failure in a surprisingly short time.

In addition, connections that suffer increased resistance may produce a localized energy dissipation, resulting in excessive heat and a marked risk of fire.

The issue of expense in connection with the conversion of energy from solar and other renewal energy resources is worthy of attention. There is a strong need to make solar power generation as cost effective as possible. While the ongoing costs of solar and other renewable-resource DC power-generation stations can be lower than for other forms of power generation, the up-front costs are typically so great that solar and other forms of DC power generation from so-called renewable resources have yet to become a viable alternative. Accordingly, system architectures, construction techniques, and materials that contribute to the excessive up-front costs of such generation systems are particularly troublesome and in need of improvement so that up-front costs may be lowered and renewable energy sources may become more competitive with non-renewable energy sources.

But the interconnection schema of conventional solar power generation arrays contributes to the excessive up-front costs. This is especially true if electronic monitoring and/or connection control is desired. During the assembly of the system, components and interconnects are conventionally mounted and all connections securely and correctly made at the installation site. This represents a significant expenditure of time, and a significant expense. Following assembly, the system must be thoroughly checked and tested for possible assembly error prior to being placed on line. The use of discrete components often results in complex and convoluted interconnect routing paths. The greater the number of interconnects and the more convoluted the routing paths, the greater the likelihood of error, and the greater the time, complexity, and expense of the final pre-activation check.

In addition to the undesirably high up-front costs, the conventional solar power generation interconnection schema also increases on-going costs. During routine maintenance and servicing, each connection point in the system should be inspected and serviced as required. The greater the number of interconnects, the greater the likelihood that a problem will develop, and the more complex such inspections become. This increase in complexity is reflected in a proportionate expenditure of time and money, in addition to a significant increase in risk to the inspecting personnel.

The diagnosis and correction of interconnect failures in a timely manner is therefore important to the proper operation of the system. This has been conventionally performed using a hands-on procedure, typically involving visual inspection of all components, the measurement of voltage drops across all connections, and the physical tightening of those connections. Because a solar generating station may contain hundred or even thousands of such systems, and because an interconnect failure may provide no overt evidence, such as a blown fuse, many hundreds or even thousands of such procedures must be performed on a routine basis in order to find and diagnose a single failure. Such diagnosis is time consuming and expensive. Because string voltages may be significant, even lethally so, such hands-on procedures are also inherently dangerous.

The fuse 19 (or other protective device) is desirably placed in series with each string to protect the system in the event of a short circuit, overload, or other failure.

The monitor circuit 20 may be placed in series with each string to more easily determine string currents. The monitor circuit may be implemented as a simple device to indicate when the string current is zero, or may be implemented as a device to indicate when the string current is outside of a predetermined range. This more sophisticated monitor circuit may be used to detect and diagnose multiple types of failure.

The switching circuit 21 may be placed in series with each string to control connection of that string. The switching circuit may be realized as a simple switch or relay to electrically disconnect a given string from the array. When that string is electrically removed, the string current falls to zero, and the potentially damaging effects of certain string failures are converted into those of a less endangering open-string failure.

The monitoring and switching circuits conventionally require signal interconnections (not shown). These interconnections, while desirably of lower voltages and currents than the higher-voltage strings, may significantly increase the complexity of overall assembly and maintenance of the system, thereby exacerbating the problems discussed.

What is needed, therefore, is a means of integrating monitoring and switching circuitry for a DC power-generation system. This means should desirably reduce the number of system interconnects and other wiring, and allow the assembly, testing, and diagnosis of the system in a manner that significantly reduces the time, costs, and dangers involved.

### SUMMARY OF THE INVENTION

Accordingly, it is an advantage of the present invention that a DC power-generation system and integral control apparatus therefor is provided.

It is an advantage of a preferred embodiment of the present invention a DC power-generation system having a reduced assembly time is provided.

It is an advantage of a preferred embodiment of the present invention that a system having a minimum of discrete components is provided.

It is an advantage of a preferred embodiment of the present invention that a DC power-generation system having a minimum number of interconnects is provided.

It is an advantage of a preferred embodiment of the present invention that a DC power-generation system having automatic string disconnection is optionally provided.

It is an advantage of a preferred embodiment of the present invention that a DC power-generation system having optional local and optional remote monitoring and operational and diagnostic control is provided.

The above and other advantages of the present invention are carried out in one form by a DC power-generation array system. The system includes a DC power-generation array comprising N strings comprising M DC power-generation cells each, where N is an integer greater than 1, and where M is a positive integer, and an integral control apparatus having a common substrate. The integral control apparatus includes a summing bus, N string units, and a process unit, all to the common substrate. Each of the N string units is coupled between one of the N strings and the summing bus, configured to measure a string current through the one string, and configured to effect electrical connection of the one string to the summing bus. The process unit is coupled to each of the N string units, configured to evaluate the string current through the one string, and configured to control electrical connection of the one string by the string unit.

The above and other advantages of the present invention are carried out in another one form by an integral control apparatus for a direct-current (DC) power-generation array formed of N strings, where N is an integer greater than 1. The apparatus includes a common substrate, a string unit affixed to the common substrate, coupled to one of the N strings, configured to measure a string current through the one string, and configured to electrically switch the one string into and out of the array, and a process unit affixed to the common substrate, coupled to the string unit, and configured to cause the string unit to electrically switch the one string into and out of the array.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a prior art direct-current power-generation array system;

FIG. 2 shows a direct-current power-generation array for use with a preferred embodiment of the present invention;

FIG. 3 shows a direct-current power-generation system for the array of FIG. 2 and incorporating an integral control apparatus in accordance with a preferred embodiment of the present invention; and

FIG. 4 shows a direct-current power-generation system for the array of FIG. 2 wherein the integral control apparatus incorporates a common dynamic load in accordance with an alternative preferred embodiment of the present invention.

### DETAILED DESCRIPTION OF THE PREFERRED EMBODIMENTS

This discussion presumes the use of a solar photovoltaic array, where the array consists of a plurality of strings of photovoltaic cells in series. It will be appreciated by those skilled in the art, however, that arrays of other “cellular” electrical generation components may be used. For example, in a thermovoltaic array, a “cell” may be a single thermocouple or thermophotovoltaic device, and a “string” may be a multitude of such devices in series, e.g., a thermopile. Alternatively, a cell might be a single voltaic cell, a single wind turbine, or the like.

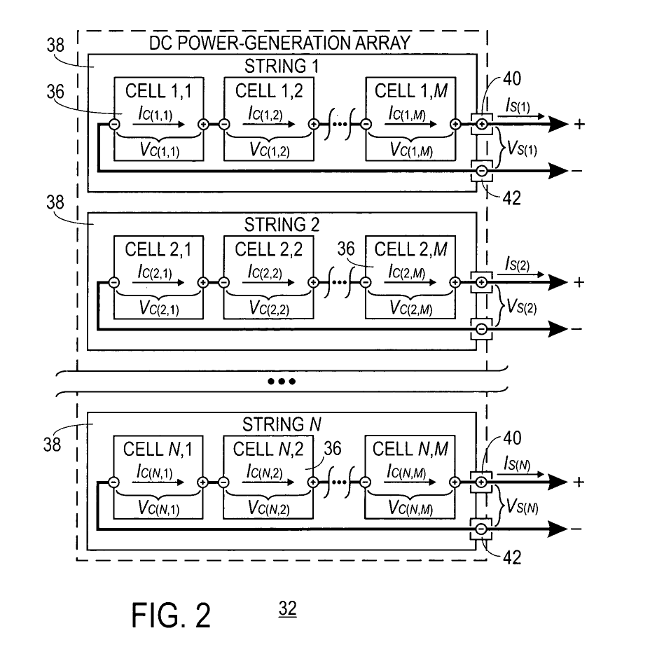

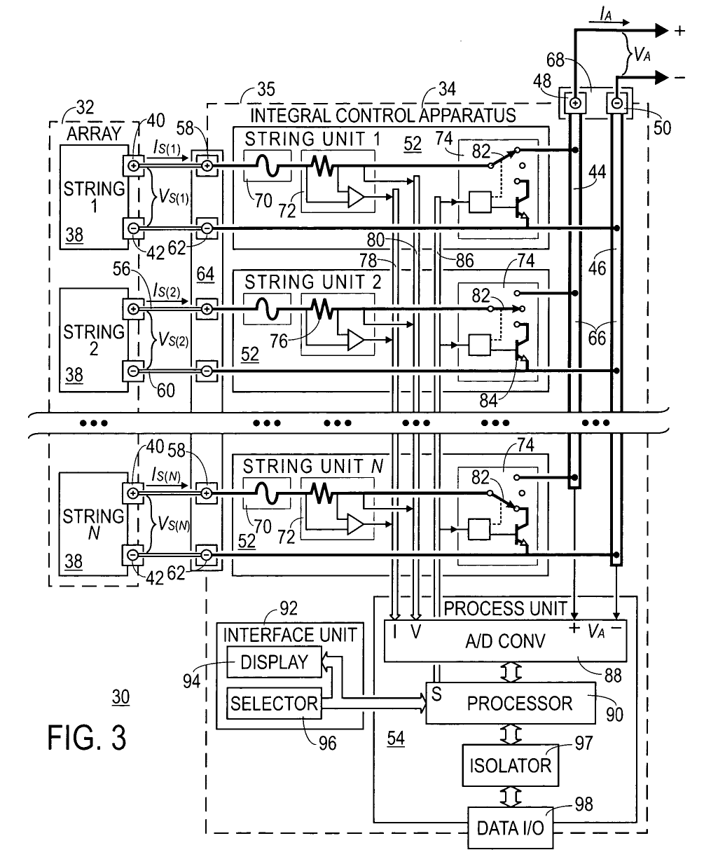

FIG. 2 shows a direct-current (DC) power-generation array 32 in accordance with a preferred embodiment of the present invention. FIG. 3 shows a DC power-generation system 30 incorporating array 32 and an integral control apparatus 34 therefor in accordance with a preferred embodiment of the present invention.

Array 32 is an array of N×M DC power-generation cells 36 arranged as N strings 38 of M cells 36 each, where N is an integer greater than 1, and M is a positive integer. Each cell 36 is configured by design to generate a cell current I_{C(X,Y)} at a cell voltage V_{C(X.Y)}, where X is a string designator having an integral value of 1, 2, . . . , N indicating in which of the N strings 38 that cell 36 is located, and Y is a cell designator having an integral value of 1, 2, . . . , M indicating the position of that cell 36 within that string 38.

The M cells 36 making up a given string 38 are electrically in series. It will be appreciated, however, that in some embodiments (not shown), a given string 38 may consist of a single cell 36 (i.e., a series of one).

A string current I_{S(X)} generated by a given string 38 passes through each cell 36 in that string 38, therefore each string 38 has a string current I_{S(X)}, where:
I_{S(X)}=I_{C(X,1)}=I_{C(X,2)}= . . . =I_{C(X,M)}. (1)
Each string 38 generates string current I_{S(X)} at a string voltage V_{S(X)}. Since the cells 36 within a string 38 are in series, the string voltage V_{S(X)} is the sum of the cell voltages V_{C(X,Y)} within that string:
V_{S(X)}=V_{C(X,1)}30 V_{C(X,2)}+ . . . +V_{C(X,M)}. (2)

Within array 32, each string 38 has a pair of string outputs 40 and 42, one for each polarity of string current I_{S(X)} generated by that string 38. All string outputs 40 of a first polarity are electrically coupled to a current summing bus 44 of that first polarity, and all string outputs 42 of a second polarity are electrically coupled to a current summing bus 46 of that second polarity. Therefore, the N strings 38 making up array 32 are electrically in parallel.

A first apparatus output 48 is taken from summing bus 44 for the first polarity, and a second apparatus output 50 is taken from summing bus 46 for the second polarity. Since the N strings 38 making up array 32 are in parallel, array 32 generates an array current I_{A} that is the sum of the string current I_{S(X)} for each of the N strings 38:
I_{A}=I_{S(1)}+I_{S(2)}+ . . . +I_{S(N)}. (3)
Array 32 generates array current I_{A} at an array voltage V_{A}. Array voltage V_{A} is impressed across each of the N strings 38. Therefore, array voltage V_{A} is substantially equal to the string voltage V_{S(X)} across each of the N strings 38:
V_{A}=V_{S(1)}=V_{S(2)}= . . . =V_{S(N)}. (4)

For the sake of convention, this document shall hereinafter presume that the first polarity is positive and the second polarity is negative. It will be appreciated by those skilled in the art that this is not a requirement of the present invention. In any given embodiment, the positive and negative polarities may be reversed without departing from the spirit of the present invention.

Integral control apparatus 34 is made up of N string units 52, summing buses 44 and 46, and a process unit 54, wherein one string unit 52 is coupled between each of the N strings 38 of array 32 and summing buses 44 and 46.

In the preferred embodiment, a positive interconnect 56 electrically couples a positive string output 40 of each string 38 to a positive apparatus input 58 of integral control apparatus 34. Similarly, a negative interconnect 60 electrically couples a negative string output 42 of each string 38 to a negative apparatus input 62 of integral control apparatus 34.

String current I_{C(X)} for a string X 38 passes from positive string output 40, through positive interconnect 56, through positive apparatus input 58, though an associated string unit 52, and to positive summing bus 44. In positive summing bus 44, string currents I_{C(1)}, . . . , I_{C(N)} from all N strings 38 are summed to become array current I_{A}. Array current I_{A} passes from positive summing bus 44 to positive apparatus output 48, and thence from system 30. Similarly, array current I_{A} returns into system 30 at negative apparatus output 50 and is passed to negative summing bus 46. In negative summing bus 46, returning array current I_{A} is divided into string currents I_{S(1)}, . . . , I_{S(N)} for each of the N strings 38. For string X 38, string current I_{S(X)} is passed from negative summing bus 46 to negative apparatus input 62, through negative interconnect 60, and thence to negative string output 42 of string X 38.

Integral control apparatus 34 is integral. That is, all components of integral control apparatus 34 are mounted to and/or upon a common substrate 35. Common substrate 35, in the preferred embodiment, is desirably a printed wiring board formed in the preferred embodiment of a non-conductive base substrate upon which are formed a multiplicity of conductive traces using printing and etching techniques well known to those skilled in the art. The conductive traces serve, in lieu of wires, to electrically couple components of string units 52 and process unit 54, summing buses 44 and 46, and any other electrically coupled components affixed to common substrate 35.

By being integral, integral control apparatus 34 is desirably prefabricated prior to installation in system 30. This greatly decreases the possibility of assembly error within integral control apparatus 34 itself, and also significantly decreases the assembly costs of integral control assembly 34.

Also, by being integral, integrated control apparatus 34 may be mounted into system 30 as a single unit. This significantly decreases the assembly time of system 30 in the field, and the costs associated therewith. Being prefabricated and integrated, integral control apparatus 34 may benefit from economies of scale and may be manufactured in large numbers at a low per-unit cost. Moreover, integral control assembly 34 may benefit from conventional low-cost production-line quality assurance techniques. Such techniques nearly guarantee that integral control apparatus 34 will work reliability when initially installed in system 30 in the field. Also, by being integrated, in the rare situation where a given integral control apparatus 34 may suffer a failure, the entire integral control apparatus 34 may be quickly, easily, and reliably replaced at low cost and without great and expensive skill in troubleshooting. Moreover, the level of skill of the installer need not be as great as with conventional solutions, leading to still further savings.

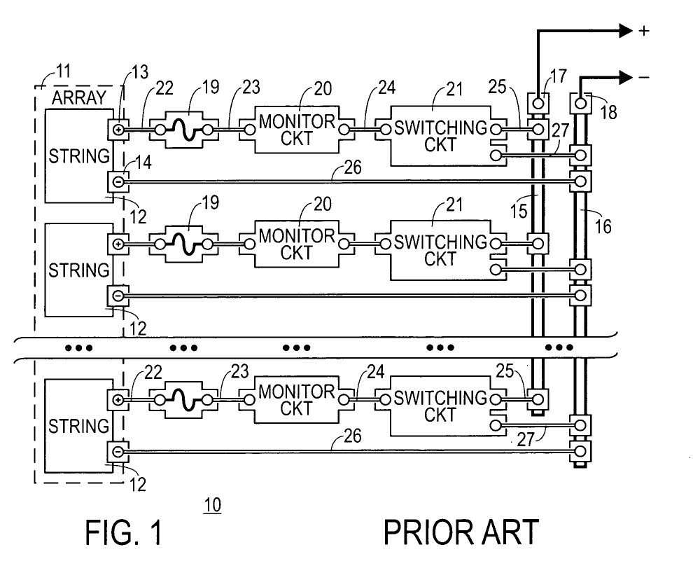

Interconnects 56 and 60 are essentially wires or cables that connect string outputs 40 and 42 to apparatus inputs 58 and 62. The connections of interconnects 56 and 60 are potential sources of failure. Therefore, the fewer interconnects 56 and 60 in system 30, the less likelihood there is of connection failure. The embodiment of system 30, as depicted in FIG. 3 and incorporating integral control apparatus 34, uses 2N interconnects 56 and 60 for an array 32 having N strings 38, having one positive interconnect 56 and one negative interconnect 60 for each string 38. This represents a significant reduction over the prior-art DC power-generation system 10 of comparable functionality depicted in FIG. 1, which has 6N interconnects 22, 23, 24, 25, 26, and 27. For example, for comparable preferred-embodiment and prior-art systems 30 and 10, each having an array 32 and 11 of fifteen strings 38 and 12, the preferred-embodiment system 30 has thirty interconnects 56 and 60, while the prior-art system 10 has ninety interconnects 22, 23, 24, 25, 26, and 27.

All interconnects 56 and 60 are routed between appropriate string outputs 40 and 42 and apparatus inputs 58 and 62. Desirably, all apparatus inputs 58 and 62 are mounted in an input terminal array 64. Input terminal array 64 may then be positioned on common substrate 35 of integral control apparatus 34 so as to minimize the routing of interconnects 56 and 60, thereby significantly decreasing the potential for short circuits and other problems in the event of a connection failure.

The use of input terminal array 64 also serves to reduce the assembly time of system 30, thereby realizing a significant further reduction in assembly costs.

All component interconnections of integral control assembly 34 may be realized as traces upon common substrate 35 thereof. As traces, the possibilities of connection failure, potential short circuits, and other problems are minimized.

In order to accommodate array current I_{A}, i.e., the sum of all string currents I_{S(1)}, . . . , I_{S(N)}, it is desirable that summing buses 44 and 46 be realized as physical bus bars 66. Preferably, bus bars 66 are affixed to a trace on common substrate 35 of integral control assembly 34 by sweat soldering or similar technique. Those skilled in the art will appreciate, however, that this is not a requirement of the present invention. Other methods of affixing bus bars 66 to integral control assembly 34 may be used without departing from the spirit of the present invention.

Desirably, apparatus outputs 48 and 50 are mounted in an output terminal array 68. Output terminal array 68 may then be positioned on common substrate 35 of integral control apparatus 34 so as to facilitate the routing of output cables (not shown) of system 30.

Each string unit 52 is electrically affixed within integral control apparatus between apparatus inputs 58 and 62 and summing buses 44 and 46 for each of the N strings 38. Each string unit 52 is made up of a fuse 70, a monitor module 72, and an optional switching module 74. Those skilled in the art will appreciate that the relative positions of fuse 70, monitor module 72, and optional switching module 74 are not a requirement of the present invention, and that other relative positions remain within the spirit of the present invention. For example, in some embodiments, it may be desirable to place fuse 70 last in sequence, proximate summing busses 44 and 46, as this would allow fuse 70 to be used as a “switch” to disconnect string unit 52 and associated string 38 from array for diagnostics and troubleshooting.

Fuse 70 is electrically coupled to the positive apparatus input 58 associated with a given string X 38. A purpose of fuse 70 is to protect array 32, system 30, and any power generating station (not shown) of which system 30 is a part, from a failure of string X 38. Another purpose of fuse 70 is to protect string X 38, and the M cells 36 within string X 38, from damage due to excessive string current I_{S(X)}. Fuse 70 provides such protection by blowing or tripping in the event of overcurrent, thereby disconnecting that string 38 from array 32. Those skilled in the art will appreciate that fuse 70 may be realized as a fuse, circuit breaker, or other like protective device without departing from the spirit of the present invention.

Monitor module 72 is electrically coupled to fuse 70. It is a purpose of monitor module 72 to measure string current I_{S(X)} of string X 38. In the preferred embodiment, monitor module 72 contains a predetermined monitor resistance 76 in series with fuse 70. Monitor resistance 76 may be realized as a distinct resistor, as the resistance of a constriction within a trace on common substrate 35 of integral control apparatus 34, or as the known resistance of a specified length of such a trace.

String current I_{S(X)} passes through monitor resistance 76. In the preferred embodiment, monitor module 72 measures string current I_{S(X)} by ascertaining the voltage drop across monitor resistance 76. A value of string current I_{S(X)} is passed to process unit 54 via a current data bus 78 (i.e., a collection of current-data conductors) extending along common substrate 35 of integral control apparatus 34. Those skilled in the art will appreciate that monitor resistance 76 may be quite small to minimize power losses, and that other methodologies may be used to measure string current I_{S(X)} without departing from the spirit of the present invention.

In some embodiments, monitor module 72 may also be configured to measure string voltage V_{S(X)} of string X 38, as depicted in FIG. 3. When string X 38 is disconnected from array 32 (discussed hereinafter), the measuring of string voltage V_{S(X)} becomes a valuable diagnostic too for the diagnosis of potential problems within string X 38.

In the embodiment shown in FIG. 3, a value of string voltage V_{S(X)} is passed to process unit 54 via a voltage bus 80 (i.e., a collection of voltage-data conductors) extending along common substrate 35 of integral control apparatus 34. Those skilled in the art will appreciate that other methodologies may be used to measure string voltage V_{S(X)} without departing from the spirit of the present invention.

Optionally, switching module 74 may be electrically coupled to monitor module 72 and positive summing bus 44, as depicted in FIG. 3. Switching module 74 is configured to electrically switch string X 38 into and out of array 32. Switching module 74 contains a switch 82 capable of electrically coupling and decoupling string 38 from array 32, i.e., to effect connection and disconnection of string 38 from summing bus 44.

In its simplest form, switch 82 may be a simple single-pole, single-throw switch or relay serving only to connect and disconnect string 38 from array 32. In the embodiment of FIG. 3, switch 82 is realized as a single-pole, double-throw, center-off, switch or relay, and possesses an “on” position, depicted in “String Unit 1” in FIG. 3, an “off” position, depicted in “String Unit 2” in FIG. 3, and a “load” position, depicted in “String Unit N” in FIG. 3. In the “on” position, switch 82 electrically couples string 38 into array 32. In the “off” position, switch 82 electrically decouples string 38 from array 32, i.e., string 38 is turned off. In the “load” position, switch 82 decouples string 38 from array 32 and couples string 38 to a dynamic load 84. Dynamic load 84 is configured to provide a load for string 38 that may vary string current I_{S(X)} from zero to a maximum allowable for string X 38.

String voltage V_{S(X)}, as measured by monitor module 72 while switch 82 is in the “load” position and string 38 is coupled to dynamic load 84, is independent of array voltage A_{V}. The use of dynamic load 84 allows string voltage V_{S(X)} to be determined for any string current I_{S(X)} from zero to a maximum value. String voltage V_{S(X)} then serves as a valuable diagnostic tool for string X 38.

Switch 82 and dynamic load 84 are under the control of process unit 54 (discussed hereinafter). Control signals are passed from process unit 54 to switching module 74 via a switching bus 86 (i.e., a collection of switching-data conductors) extending along common substrate 35 of integral control apparatus 34.

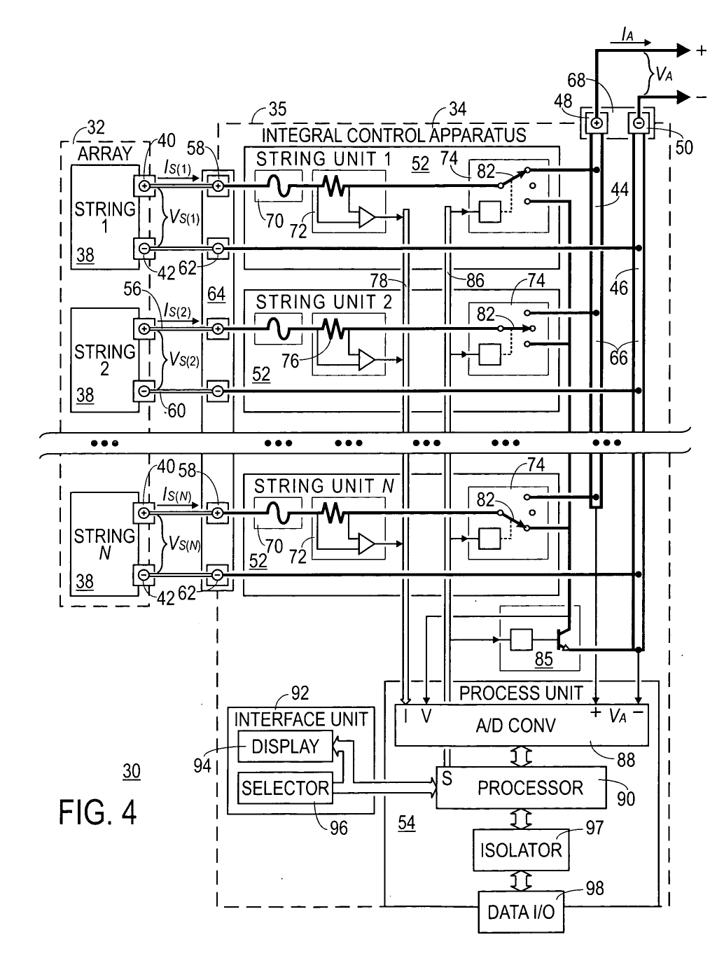

FIG. 4 shows system 30 wherein integral control apparatus 34 incorporates a common dynamic load 85 in accordance with an alternative preferred embodiment of the present invention. The following discussion refers to FIGS. 2, 3, and 4.

In FIG. 3, each switching module 74 incorporates a separate dynamic load 84. In the FIG. 3 embodiment, multiple strings 38 may be coupled to dynamic loads 84 substantially simultaneously. However, since each string 38 may pass a significant string current IS_{(X)} at a significant string voltage VS_{(X)}, each dynamic load may be required to dissipate a considerable amount of power. This typically necessitates the use of heat sinks or other bulky devices. The physical inclusion of these devices, for each of the N strings 38, may add considerably to the size, weight, and complexity of integral control apparatus 34.

In the alternative embodiment of FIG. 4, the use of N dynamic loads 84 has been replaced by the use of a common dynamic load 85. Common dynamic load 85 is “multiplexed” among switching modules 74 by process unit 54 (discussed hereinafter). Through the use of common dynamic load 85, only one heat sink or other heat-dissipating device need be incorporated into integral control assembly 34. Since common dynamic load 85 is multiplexed among switching modules 74, the current and voltage through common dynamic load 85 never exceeds the current IS_{(X)} and voltage VS_{(X)} of a single string 38. The use of the common-load or “multiplex” embodiment of FIG. 4 therefore reduces the size, weight, and complexity of integral control apparatus 34 over the multiple-load embodiment of FIG. 3.

Those skilled in the art will appreciate that other methodologies may be used to control switch 82 and/or dynamic loads 84 and/or 85, e.g., an embodiment (not shown) having multiple common dynamic loads 85, without departing from the spirit of the present invention.

When a given string X 38 is coupled to dynamic load 84 (FIG. 3) or 85 (FIG. 4), it is desirable for string current I_{S(X)} to return to that string 38, i.e., there needs be a complete circuit. This is accomplished by having a trace along common substrate 35 of integral control apparatus 34 electrically connect a return leg of each dynamic load 84 or 85 to negative apparatus input 62 of integral control apparatus 34. Negative apparatus input 62 is coupled by negative interconnect 56 to negative string output 42 of string X 38.

Integral control apparatus 34 also includes process unit 54. Process unit 54 is coupled to each of the N string units 52. For a given string unit 52, process unit 54 is coupled to and receives a value of string current I_{S(X)} from monitor module 72 via current bus 78. In the preferred embodiment, the value of string current I_{S(X)} through each string 38 is digitized by an analog-to-digital (A/D) converter 88 and passed to a processor 90. Processor 90 may determine array current I_{A} as the sum of all string currents I_{S(1)}, . . . , I_{S(N)}. Processor 90 may then determine if a given string current I_{S(X)} is too low or too high, i.e., not within a predetermined range.

In a similar manner, for the embodiment depicted in FIG. 3, process unit 54 is coupled to and receives a value of string voltage V_{S(X)} from monitor module 72 via voltage bus 80 when switching module 74 has coupled string 38 to dynamic load 84. In the preferred embodiment, the value of string voltage V_{S(X)} across that string 38 is digitized by A/D converter 88, as is a value of array voltage A_{V} derived from summing buses 44 and 46, and passed to a processor 90. Processor 90 may determine if that string voltage V_{S(X)} is too low or too high relative to array voltage A_{V}.

In the embodiment depicted in FIG. 4, voltage bus 80 is omitted but string voltage V_{S(X)} for any string switched to dynamic load 85 is routed to A/D converter 88 for measurement and subsequent processing in processor 90.

When optional switching modules 74 are used, process unit 54 is coupled to each switching module 74 via switching bus 86. Processor 90 sends instructions to switching modules 74 controlling the throw of switch 82 and determining the value of dynamic load 85. These instructions may but need not be issued automatically. For example, under control of a suitable program, processor 90 may determine string currents I_{S(1)}, . . . , I_{S(N)} for each of the N strings 38, determine array current I_{A}, then instruct a given switching module 74 to disconnect the associated string 38 from array 32 when string current I_{S(X)} for that string 38 is outside a given range relative to array current I_{A}.

In a similar scenario, processor 90 may, under control of a suitable program, determine array voltage V_{A}, cyclically instruct switching modules 74 to switch each string 38 in turn to dynamic load 84 and set dynamic load 84 to an appropriate value, and determine string voltage V_{S(X)} for each string 38. Strings 38 having a string voltage V_{S(X)} not within a predefined range relative to array voltage V_{A} may be kept disconnected.

Those skilled in the art will appreciate that integral control apparatus 34 may also monitor and base decisions upon other parameters not depicted herein, e.g., temperature. The monitoring and utilization of these other parameters does not depart from the spirit of the present invention.

Integral control apparatus 34 may also comprise an optional interface unit 92 configured to allow electronic access to processor 90, and hence to integral control apparatus 34, for an operator in the field. Interface unit 92 includes a display module 94 and a selector module 96. Display module 94 is configured to display the status of system 30 to the operator. Selector module 96 allows the operator to select what is to be displayed upon display module 94, and to control operation of processor 90 and switching modules 74.

For example, through the use of interface unit 92, the operator may take control of processor 90 and perform diagnostic checks of system 30 without the necessity of physically probing into the circuitry. This provides for a significant lessening of the time require for field diagnostics, thereby lowering service costs and increasing efficiency. This also significantly decreases the danger of accidental damage to the equipment or injury to the operator.

Desirably, process unit 54 also includes an optional data input/output (I/O) module 98. Data I/O module 98 is configured to be connected to a remote location via RS-232 or other data link well known to those of ordinary skill in the art. Through the use of data I/O module 98, all the functionality of interface unit 92 may be realized remotely. This minimizes the number of physical trips into the field that must be taken for diagnostics, thereby further reducing costs.

In addition, the use of data I/O module 98 allows processor 90 to report the status of all strings 38 automatically or upon demand, and provides for notification of string disconnection. This allows diagnosis and repair to occur in a timely manner and increases the overall efficiency of system 30.

Those skilled in the art will appreciate that neither interface unit 92 nor data I/O module 98 is a requirement of the present invention. Embodiments lacking either interface unit 92 or data I/O module 98 may be realized without departing from the spirit of the present invention.

Desirably, data I/O module is electrically isolated from the voltages and currents present in integral control apparatus by galvanic isolator 97. Galvanic isolator 97 serves to protect equipment at the remote location and any intervening locations from damage by voltages that may be propagated due to a failure of or damage to integral control apparatus 34. More importantly, galvanic isolator 97 protects personnel from injury or death that may occur with exposure to such voltages. Those skilled in the art will appreciate that, while highly desirable, the inclusion of galvanic isolator 97 is not a requirement of the present invention. Exclusion of galvanic isolator 97 does not depart from the spirit of the present invention.

In summary, the present invention provides a DC power-generation system 30 and integral control apparatus 34 therefor. System 30 has a minimum number of discrete components and a minimum number of inter-component interconnects 56 and 60, resulting in reduced assembly and diagnostic times and costs, and a marked increase in operator safety. System 30 provides for optional automatic disconnection of defective strings 38 within a DC power-generation array 32, and both optional local and optional remote monitoring and control of system diagnostics and operation.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A direct-current (DC) power-generation array system comprising:
a DC power-generation array comprising N strings comprising M DC power-generation cells each, where N is an integer greater than 1, and where M is a positive integer; and
an integral control apparatus having a common substrate and comprising:
a current summing bus affixed to said common substrate and coupled to each of said N strings;
N string units affixed to said common substrate, wherein each of said N string units is coupled between one of said N strings and said current summing bus, and configured to measure a string current through said one string; and
a process unit affixed to said common substrate, coupled to each of said N string units, and configured to evaluate said string current through said one string.

2. A system as claimed in claim 1 wherein said process unit is configured to control electrical connection of said one string to said array.

3. A system as claimed in claim 1 wherein:
said integral control apparatus additionally comprises an interface unit affixed to said common substrate and coupled to said process unit; and
said process unit is configured to control connection of said one string in response to an instruction from said interface unit.

4. A system as claimed in claim 1 wherein:
each of said N string units is configured to effect electrical connection of said one string to said current summing bus; and
said process unit is configured to control electrical connection of said one string by said string unit.

5. A system as claimed in claim 4 wherein each of said N string units comprises:
a monitor module coupled to said one string and configured to measure said string current through said one string; and
a switching module coupled between said monitor module and said current summing bus and configured to effect electrical connection of said one string and said current summing bus.

6. A system as claimed in claim 5 wherein said switching module is configured to effect electrical connection of said one string with one of said current summing bus and a dynamic load.

7. A system as claimed in claim 5 wherein said process unit comprises a processor coupled to said monitor module and switching module, configured to evaluate said string current measured by said monitor module, and configured to control connection of said one string by said switching module.

8. A system as claimed in claim 5 wherein said process unit comprises:
a data input/output (I/O) module in communication with a remote location; and
a processor coupled to said data I/O module, coupled to said switching module, and configured to control connection of said one string by said switching module in response to instructions from said remote location.

9. A system as claimed in claim 1 wherein:
said current summing bus is a first current summing bus configured to produce an output of said array of a first polarity; and
said integral control apparatus additionally comprises a second current summing bus coupled to said N strings and configured to produce an output of said array of a second polarity.

10. A system as claimed in claim 9 wherein said N string units are coupled to said first current summing bus and said second current summing bus.

11. A system as claimed in claim 9 wherein:
said each string unit is configured to effect an electrical connection of said one string to one of said first current summing bus and a dynamic load.

12. A system as claimed in claim 11 wherein:
said dynamic load is a common dynamic load; and
each of a plurality of said N string units is configured to connect one of said strings to said common dynamic load.

13. A system as claimed in claim 11 wherein said integral control apparatus is configured to measure a string voltage of said one string when said one string is coupled to said dynamic load.

14. A system as claimed in claim 1 wherein, for each of said N strings, said system additionally comprises:
a first interconnect coupled between a first output of each of said N strings and a first input of said integral control apparatus; and
a second interconnect coupled between a second output of each of said N string units and a second input of said integral control apparatus.

15. An integral control apparatus for a direct-current (DC) power-generation array formed of N strings, where N is an integer greater than 1, said apparatus comprising:
a common substrate;
a string unit affixed to said common substrate, coupled to one of said N strings, and configured to measure a string current through said one string; and
a process unit affixed to said common substrate, coupled to said string unit, and configured to evaluate said string current though said one string.

16. An apparatus as claimed in claim 15 wherein said common substrate comprises:
a non-conductive base substrate; and
a multiplicity of conductive traces formed upon said non-conductive base substrate, wherein said conductive traces serve to connect components of said string units and said process unit affixed to said common substrate.

17. An apparatus as claimed in claim 16 wherein:
said string unit is configured to electrically switch said one string into and out of said array; and
said process unit is configured to cause said string unit to electrically switch said one string into and out of said array.

18. An apparatus as claimed in claim 17 wherein said process unit is configured to evaluate said string current and to cause said string unit to electrically switch said one string into and out of said array in response to said string current.

19. An apparatus as claimed in claim 18 wherein:
said process unit is configured to switch said one string into said array when said string current is evaluated to be within a predetermined current range; and
said process unit is configured to switch said one string out of said array when said string current is evaluated to be outside of said predetermined current range.

20. An apparatus as claimed in claim 15 wherein said string unit comprises:
a monitor module coupled to said one string and configured to measure said string current through said one string; and
a switching module coupled to said monitor module and configured to electrically switch said one string into and out of said array.

21. An apparatus as claimed in claim 20 wherein said process unit comprises a processor coupled to said monitor module, coupled to said switching module, configured to evaluate said string current, and configured to cause said switching module to switch said one string out of said array upon one of said string current is evaluated to be outside of a predetermined current range and upon operator command.

22. An apparatus as claimed in claim 21 wherein said process unit additionally comprises an analog to digital converter coupled between said monitor module and said processor and configured to digitize a value of said string current.

23. An apparatus as claimed in claim 15 wherein said string unit is one of N substantially identical string units, and wherein each of said N string units is coupled to one of said N strings, coupled to said process unit, and coupled to a current summing bus configured to electrically sum said string current through each of said N strings to produce an array current.

24. A direct-current (DC) power-generation array system comprising:
a DC power-generation array comprising N×M DC power-generation cells arranged as N strings of M cells each, where N is an integer greater than 1, and where M is a positive integer;
an integral control apparatus comprising:
a common substrate:
N string units affixed to said common substrate, wherein each of said N string units is coupled to one of said N strings and comprises:
a monitor module configured to measure a string current through said one string; and
a switching module configured to effect electrical couple and decouple said one string with a remainder of said N strings;
a current summing bus affixed to said common substrate, coupled to each of said N string units, and configured to sum said string currents from each of said N strings;
a process unit comprising:
a processor coupled to each of said monitor modules, coupled to each of said switching modules, configured to evaluate each of said string currents through said N strings, and configured to cause said switching modules to couple and decouple said strings with said array; and
a data input/output module configured to provide a remote control of said processor; and
an interface unit affixed to said common substrate, coupled to said process unit, and configured to provide local control of said processor, wherein said processor is configured to cause each of said switching modules to one of couple and decoupled an associated one of said strings with said array in response to one of an automatic control, said remote control, and said local control
